(19) United States
(12) Patent Application Publication
(10) Pub. No.: US 2010/0145859 A1
(43) Pub. Date: Jun. 10, 2010

(54) CONTROL DEVICE, REPRODUCING DEVICE, PERMISSION SERVER, METHOD FOR CONTROLLING CONTROL DEVICE, METHOD FOR CONTROLLING REPRODUCING DEVICE, AND METHOD FOR CONTROLLING PERMISSION SERVER

(76) Inventors: Shingo Murakami, Kanagawa (JP); Toshikane Oda, Tokyo (JP); Johan Hjelm, Tokyo (JP)

Correspondence Address: ERICSSON INC., 6300 LEGACY DRIVE, M/S EVR 1-C-11, PLANO, TX, 75024, US

(21) Appl. No.: 12/523,446

(22) PCT Filed: Jan. 16, 2007
(86) PCT No.: PCT/JP2007/050871

§ 371 Date: Feb. 18, 2010

(51) Int. Cl. H04L 9/30; G06Q 10/00; H04L 9/32; G06Q 50/00

(52) U.S. Cl. 705/54; 705/310

(57) ABSTRACT

A control device comprising control means for controlling a reproducing device to reproduce multimedia data is provided. The control device also comprises receiving means for receiving, from the reproducing device, a request to acquire permission data, which is contained in a permission server, said permission data enabling reproduction of the multimedia data, and said request comprising location information that indicates a location of the permission data and authentication information of the reproducing device, acquiring means for acquiring the permission data from the location indicated by the location information, said acquiring means sending the authentication information to the permission server, and sending means for sending the permission data to the reproducing device.

### TECHNICAL FIELD

The present invention generally relates to technology for acquiring permission that enables reproduction of protected multimedia data.

### BACKGROUND

### OMA DRM 2.0

Open Mobile Alliance (OMA) released an approved enabler of Digital Rights Management Version 2 (OMA DRM 2.0) on Mar. 3, 2006 [1]. The OMA DRM 2.0 Enabler Release defines the protocols, messages and mechanisms necessary to implement the DRM system in the mobile environment.

In OMA DRM 2.0, the same as other similar DRM systems, protected contents are delivered to user devices and the contents can be consumed along with particular Rights Objects (ROs). The ROs can be acquired through a network in a secure way and this acquisition mechanism is an essential part of the OMA DRM 2.0 specification. It is specified as Rights Object Acquisition Protocol (ROAP) and it involves two important OMA DRM 2.0 entities: “Device” and “Rights Issuer”.

The followings are formal definitions in OMA DRM 2.0 of Device, Rights Issuer, and definitions relevant to them:
Device: An entity (hardware, software, or combination thereof) within the user-equipment that implements a DRM Agent.
Rights Issuer: An entity that issues Rights Objects to OMA DRM-conformant Devices.
DRM Agent: The entity in the Device that manages Permissions for Media Objects on the Device.
Permission: Actual usages or activities allowed (by the Rights Issuer) for Protected Content
Media Object: A digital work e.g. a ringing tone, a screen saver, or a Java® game.
Protected Content: Media Objects that are consumed according to a set of Permissions in a Rights Object.
Rights Object (RO): A collection of Permissions and other attributes which are linked to Protected Content.

The detailed mechanisms of ROAP, e.g. how a Device must interact with a Rights Issuer to register itself, acquire ROs, etc., are found in the OMA DRM Specification [1].

Charging System:

OMA DRM 2.0 can be utilized to control consumption of a Media Object. Accordingly, the provider of a Media Object (hereinafter referred to as “content provider” can charge consumers by utilizing OMA DRM 2.0. More specifically, the content provider can charge consumers for RO acquisitions.

Although the OMA DRM 2.0 standard does not specify how RO acquisitions are charged in a real system, according to one of the known systems, a “Device” (identified by a Device ID) is associated in advance with the user's (owner's) charging information (e.g. credit-card number etc.) at the content provider. In the case that the “Device” is a mobile terminal equipped with SIM (Subscriber Identity Module), the charging information may be IMSI (International Mobile Subscriber Identity). RO acquisition conducted by that Device is automatically charged according to the pre-associated charging information. The following is a detailed description of this system.

In OMA DRM 2.0, a “Device” is the only standard entity the Rights Issuer can recognize as a requesting source of RO acquisition over ROAP. The corresponding Device ID is the only defined identifier by which the Rights Issuer can uniquely distinguish Devices from one another (the only Device ID currently defined is the hash of the Device's public key). In this system, the Device ID is used as a means to identify the subject to be charged.

The Device ID is associated with charging information of the owner of the Device. It's highly likely that some owners possess more than one Device (see FIG. 1). In FIG. 1, Owner-A possesses a Device X and a Device Y, and Device IDs of both Devices are associated with charging information of Owner-A. Accordingly, RO acquisitions conducted by Device X and Device Y can both be charged to Owner-A. A charging function, which is not standardized in OMA DRM 2.0, manages association between owners and Device IDs.

Authentication:

It is desirable that the Rights Issuer authenticates a Device before issuing an RO to the Device. This is because if the Device is hacked, contains security bugs, or is designed maliciously etc., it may make bad use of the RO. For example, the Device may “steal” the decrypted Media Object and provide it to unauthorized users without DRM protection. This may damage the content provider (i.e., right holder of the Media Object).

One way for the Rights Issuer to know if a Device, which is issued with an RO, is credible or not is to check the revocation status of the certificate of the Device, e.g. via OCSP (Online Certificate Status Protocol) [2]. Once the Device becomes compromised, for example, it is likely that the Device's certificate is revoked within the concerned PKI system since the vendor of the Device, which had installed the certificate on the device at factory, should request the PKI system to revoke the certificate.

Sub-License of an RO:

The charging system discussed causes a problem in the case that the “owner” of a Device and the “user” of the Device are different. This case occurs when, for example, the user uses Devices, in an ad-hoc manner, which are available in a number of visited places, e.g., hotels, friends' houses, visited offices, cafés, stations, etc. In this case, the owner of the Device which acquires the RO is eventually charged instead of the user who actually consumes Media Object.

In order to deal with this problem, the technology of sub-licensing an RO (hereinafter referred to as “sub-licensing technology”) is known [3][4]. The sub-licensing technology enables a Device that originally acquires an RO from a Rights Issuer to further issue a sub-license of that RO (hereinafter referred to as “sub-RO”), which contains full or partial Permissions of the original RO, to other Devices.

FIG. 2 illustrates a basic idea of sub-licensing technology. A Device 220 is owned by a user who actually consumes Media Object. A Device 1 (231) to a Device m (233) are all owned by owners different from the user.

Assume that the Device 1 (231) is a personal computer (PC) that can retrieve movie data via the Internet, and is located in a hotel room and owned by the hotel. When a user wishes to view a movie that is protected by DRM, the Device 220, which is, e.g., a cellular phone of the user, first acquires an RO (an original RO) for that movie. The Device 220 then issues sub-RO to the Device 1 (231) based on the original RO, and the Device 1 (231) reproduces the movie according to the issued sub-RO.

Because the Device 220 owned by the user first acquires the RO, a content provider (i.e., right holder of the movie) can charge the user who actually views the movie, not the hotel owning the Device 1 (231).

Existing Problem in Sub-Licensing Technology:

If sub-licensing technology is utilized, it is required that the sub-licensing Device (e.g., the Device 220) authenticates the sub-licensed Device (e.g., the Device 1 (231)) before issuing the sub-RO in order to ensure that it is an authorized (credible) Device to use the sub-RO. It is preferable that the sub-licensing Device checks the revocation status of sub-licensed Devices by communicating with the PKI system via e.g. OCSP every time it authenticates the Devices in order to be assured of credibility of the authenticated devices.

However, this is definitely a costly operation for the sub-licensing Device because computational capacity and bandwidth of the sub-licensing Device are usually limited compared with the Rights Issuer. This problem is especially serious in situations where the sub-licensing Device is e.g. a cellular phone and billing for data communication is based on the amount of transmitted/received traffic.

### SUMMARY

The feature of the present invention is to solve the pre-existing problem.

According to an aspect of the present invention, there is provided a control device comprising: control means for controlling a reproducing device to reproduce multimedia data; receiving means for receiving, from the reproducing device, a request to acquire permission data, which is contained in a permission server, the permission data enabling reproduction of the multimedia data, and the request comprising location information that indicates a location of the permission data and authentication information of the reproducing device; acquiring means for acquiring the permission data from the location indicated by the location information, the acquiring means sending the authentication information to the permission server; and sending means for sending the permission data to the reproducing device.

According to another aspect of the present invention, there is provided a reproducing device comprising: command receiving means for receiving, from a control device, a command to reproduce multimedia data; obtaining means for obtaining, based on the multimedia data, location information that indicates a location of permission data, which is contained in a permission server, the permission data enabling reproduction of the multimedia data; sending means for sending, to the control device, a request to acquire the permission data, the request comprising the location information and authentication information of the reproducing device; permission receiving means for receiving, from the control device, the permission data as a response to the request; and reproducing means for reproducing the multimedia data using the permission data.

According to another aspect of the present invention, there is provided a permission server comprising: location sending means for sending, to a reproducing device, location information that indicates a location of permission data, which is contained in the permission server, the permission data enabling reproduction of multimedia data; receiving means for receiving, from a control device, a request to acquire the permission data from the location indicated by the location information, the request comprising authentication information of the reproducing device; determination means for determining whether or not the reproducing device is authenticated based on the authentication information; and permission sending means for sending the permission data to the control device in response to the request in case that the determination means determines that the reproducing device is authenticated.

According to another aspect of the present invention, there is provided a method of controlling a control device comprising: a control step of controlling a reproducing device to reproduce multimedia data; a receiving step of receiving, from the reproducing device, a request to acquire permission data, which is contained in a permission server, the permission data enabling reproduction of the multimedia data, and the request comprising location information that indicates a location of the permission data and authentication information of the reproducing device; an acquiring step of acquiring the permission data from the location indicated by the location information, wherein in the acquiring step the authentication information is sent to the permission server; and a sending step of sending the permission data to the reproducing device.

According to another aspect of the present invention, there is provided a method for controlling a reproducing device comprising: a command receiving step of receiving, from a control device, a command to reproduce multimedia data; an obtaining step of obtaining, based on the multimedia data, location information that indicates a location of permission data, which is contained in a permission server, the permission data enabling reproduction of the multimedia data; a sending step of sending, to the control device, a request to acquire the permission data, the request comprising the location information and authentication information of the reproducing device; a permission receiving step of receiving, from the control device, the permission data as a response to the request; and a reproducing step of reproducing the multimedia data using the permission data.

According to another aspect of the present invention, there is provided a method for controlling a permission server comprising: a location sending step of sending, to a reproducing device, location information that indicates a location of permission data, which is contained in the permission server, the permission data enabling reproduction of multimedia data; a receiving step of receiving, from a control device, a request to acquire the permission data from the location indicated by the location information, the request comprising authentication information of the reproducing device; a determination step of determining whether or not the reproducing device is authenticated based on the authentication information; and a permission sending step of sending the permission data to the control device in response to the request in case that the determination step determines that the reproducing device is authenticated.

The main advantage of the present invention is as follows. The permission server, instead of the control device, authenticates the reproducing device that actually consumes permission issued by the permission server. Accordingly, processing load for the control device, which has relatively small bandwidth and less processing power compared with the permission server, is reduced.

Further features of the present invention will become apparent from the following description of exemplary embodiments with reference to the attached drawings, in which like reference characters designate the same or similar parts throughout the figures thereof.

### BRIEF DESCRIPTION OF DRAWINGS

FIG. 1 illustrates an example of association between owners and Device IDs.

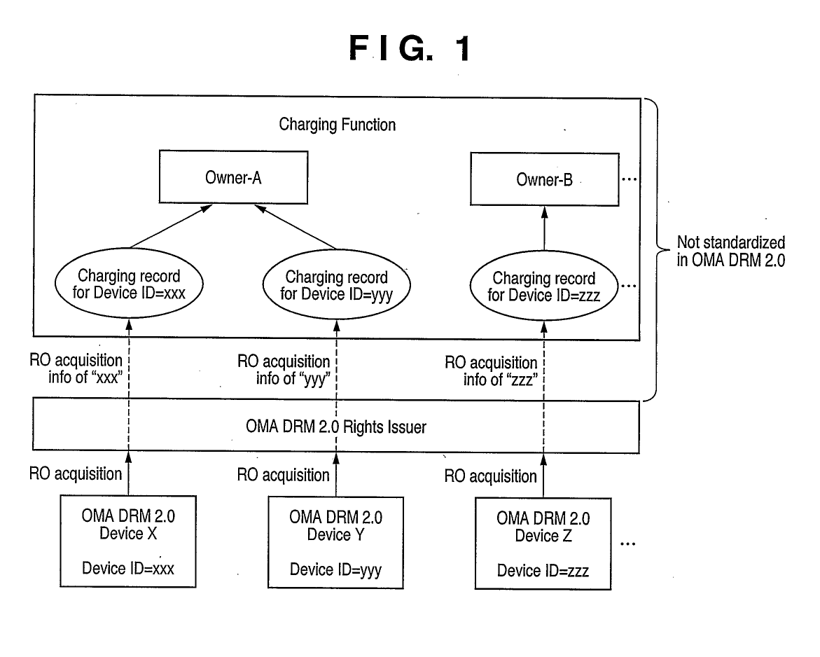

FIG. 2 illustrates a basic idea of sub-licensing technology.

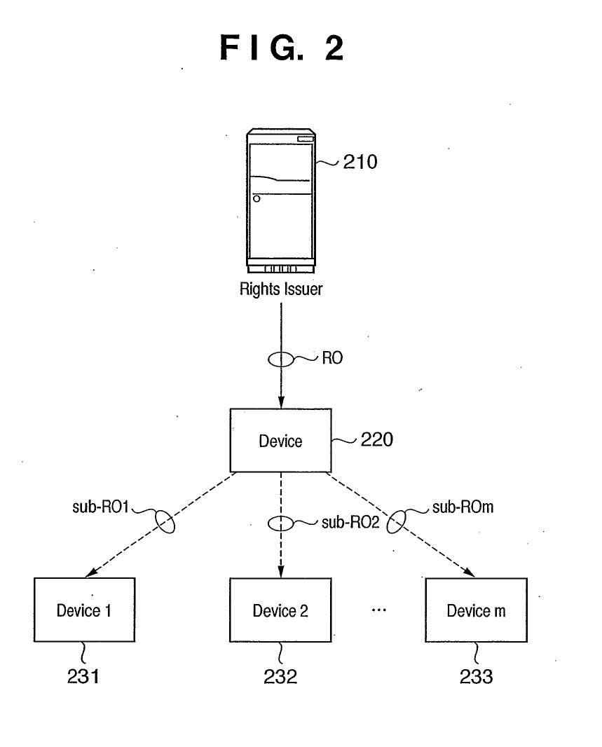

FIG. 3 illustrates an overview of a reproducing system according to the embodiment.

FIG. 4 illustrates a UPnP AV (Audio Visual) device interaction model.

FIG. 5 illustrates an example procedure of how to associate an OMA DRM Device (i.e. the control device) with charging information.

FIG. 6 illustrates a block diagram of the control device of the reproducing system.

FIG. 7 illustrates a block diagram of the reproducing device of the reproducing system.

FIG. 8 illustrates a block diagram of the Rights Issuer of the reproducing system 300.

FIG. 9 is a flowchart showing process performed in the reproducing system.

FIG. 10 illustrates an example of SDP returned by the content server.

FIG. 11 illustrates an example of the request message sent by the reproducing device to the control device.

FIG. 12 illustrates an example of the endorsed request message sent by the control device to the Rights Issuer.

### DETAILED DESCRIPTION

### Reproducing System

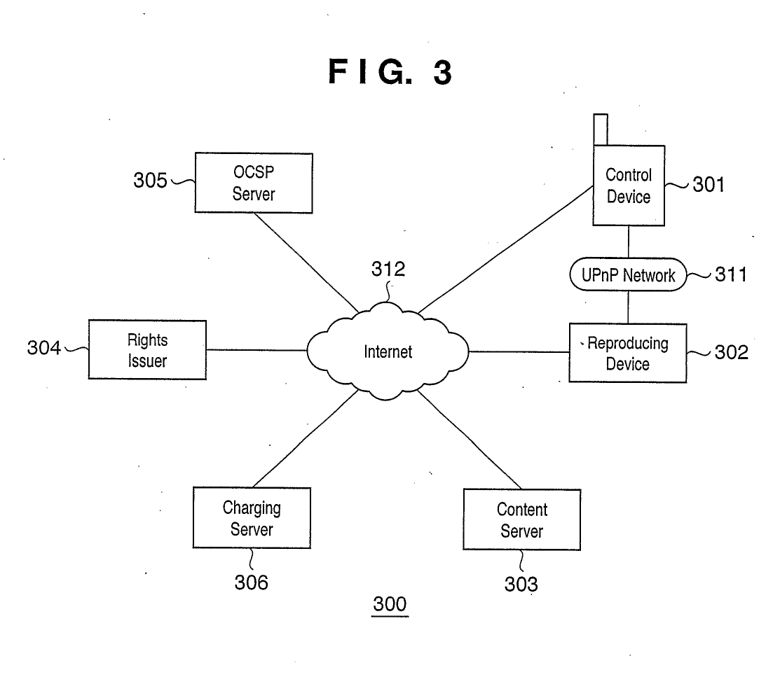

FIG. 3 illustrates an overview of a reproducing system 300 according to the embodiment.

In the reproducing system 300, a control device 301 controls a reproducing device 302 to reproduce multimedia data (Media Object). An owner of the control device 301 is a user who operates it and consumes (i.e., reads, views, listens to, etc.) the Media Object. The control device 301 may be any kind of device such as a cellular phone, a Personal Digital Assistant (PDA), a notebook computer, and so on.

The reproducing device 302 may be any kind of device such as a television (TV), a PC, and so on as long as it can reproduce the Media Object. The reproducing device 302 is owned by a person (or organization) different from the owner of the control device. The reproducing device 302 reproduces the Media Object in response to the control of the control device 301.

The control device 301 and the reproducing device 302 are connected to each other via a Universal Plug and Play (UPnP) network 311 (explained in detail later). In an exemplary embodiment, the reproducing device 302 is a TV located in a hotel room, and the owner of the control device 301 is a hotel guest. However the control device 301 and the reproducing device 302 may be connected using any connection scheme other than UPnP.

A content server 303 contains Media Objects and provides them for the reproducing device 302 via the Internet 312. In the explanation hereafter, it is assumed that the Media Objects are protected (decrypted) based on OMA DRM 2.0. The content server 303 also provides a list of Media Objects, which is available at the reproducing device 302, with the control device 301. The content server 303 may, for example, be a server operated by a content provider, or a Hard Disk Drive (HDD) recorder owned by the owner of the control device 301. In some embodiments, the reproducing device 302 may have a storage containing Media Objects and retrieve them from the storage, instead of the content server 303.

A Rights Issuer 304 issues ROs that enable reproduction of Media Objects contained in the content server 303 (or a storage of the reproducing device 302) to the control device 301. As the Rights Issuer 304 issues ROs comprising Permissions, it is also called a permission server in the embodiment.

An OCSP server 305 manages Certificate Revocation List (CRL). If it is detected that the reproducing device 302 is hacked or it contains some security bugs, the certification of the reproducing device 302 is added to CRL. Accordingly, the Rights Issuer 304 can determine whether or not the reproducing device 302 is authenticated (i.e. credible) before issuing ROs by accessing the OCSP server 305 via OCSP.

A charging server 306 charges the owner of the control device 301 for ROs issued by the Rights Issuer 304. The charging server 306 has charging information for the owner, which is associated with identification (e.g. Device ID) of the control device 301. When the Rights Issuer 304 issues an RO, it receives the Device ID of the control device 301 and forwards it to the charging server 306 with pricing information. Accordingly, the charging server 306 can charge the owner for the issued RO.

It should be noted that some of the entities shown in FIG. 3 may be implemented in a single entity. For example, the Rights Issuer 304 and the charging server 306 may be implemented in the same server.

UPnP:

As explained above, the control device 301 and the reproducing device 302 may use UPnP for their connection. In this section is provided the detailed explanation of UPnP.

UPnP is an industrial standard for interoperable home appliances such as AV devices etc. UPnP Device Architecture is the basis for all UPnP functions specified in separate UPnP Device and Service descriptions. This embodiment is most characterized by UPnP AV Architecture and relevant UPnP Device and Service specifications.

The UPnP AV architecture introduces UPnP MediaServer [9] and UPnP MediaRenderer [10] devices and shows ways of how media content (e.g., video, audio, image etc.) stored in the MediaServer is rendered on a MediaRenderer under control of UPnP Control Point (CP).

It should be noted that MediaServer, MediaRenderer and CP are only logical entities, so any sets of MediaServer, MediaRenderer and CP can be implemented in a single physical device.

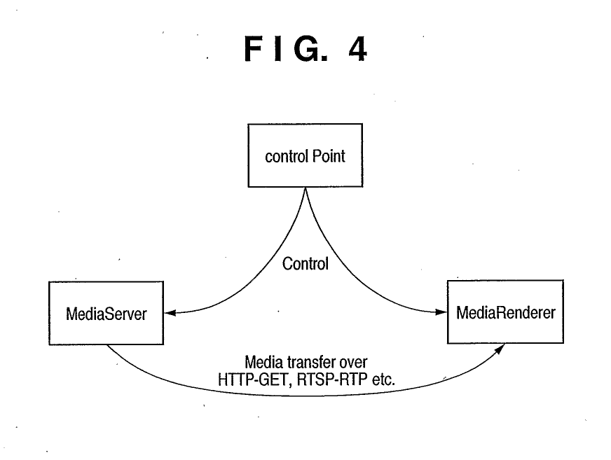

FIG. 4 illustrates a UPnP AV device interaction model. CP plays the central role of coordinating and synchronizing actions of both MediaServer and MediaRenderer. Although CP uses UPnP protocols to initialize and configure both devices so that the desired content is transferred from MediaServer to MediaRenderer, MediaServer and MediaRenderer themselves interact with each other using a non-UPnP communication protocol such as HTTP-GET or RTSP-RTP.

In the reproducing system 300 shown in FIG. 3, the control device 301 serves as CP and the reproducing device 302 serves as MediaRenderer. Although the content server 303 does not serve as MediaServer because it is not connected via the UPnP network 311 but the Internet 312, the reproducing device 302 can receive Media Objects from the content server 303 using any kind of protocol such as Hyper Text Transfer Protocol (HTTP), File Transfer Protocol (FTP), Real Time Streaming Protocol (RTSP), and so on. It should be noted that if the content server 303 can connect with the control device 301 and the reproducing device 302 using UPnP, it may serve as MediaServer.

Association Between Device ID and Charging Information:

As discussed above, Device ID of the control device 301 should be associated with charging information of the owner of the control device 301 in advance in order to enable the charging server 306 to charge the owner for the issued RO.

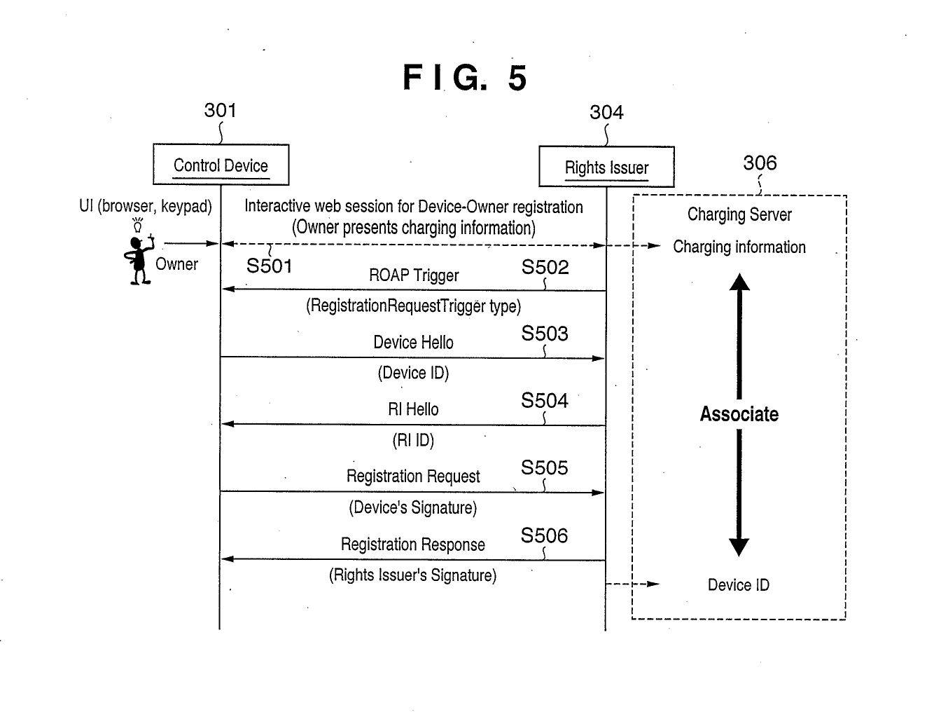

FIG. 5 illustrates an example procedure of how to associate an OMA DRM Device (i.e. the control device 301) with charging information.

In step S501, the owner first accesses to e.g. Device-Owner registration web pages provided by Rights Issuer 304 with a built-in browser of the control device 301. On this interactive web page, the owner presents necessary charging information (e.g. credit card number) to be associated with the control device 301. In step S502, after successful supplement of the charging information in step S501, Rights Issuer sends a ROAP Trigger to the control device 301. The trigger type of the ROAP Trigger is Registration Request Trigger to prompt the Device to initiate ROAP registration.

The subsequent 4-pass ROAP Registration protocol [1] (S503˜S506) enables the Rights Issuer to associate the presented charging information with the registered Device ID.

### Control Device:

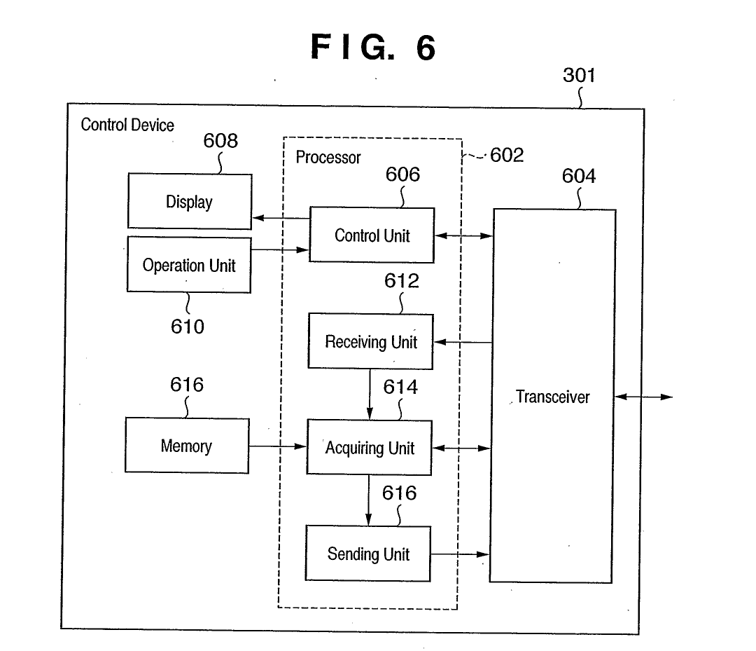

FIG. 6 illustrates a block diagram of the control device 301 of the reproducing system 300. A processor 602 executes computer programs such as firmware and an operating system, thereby controlling each of the components contained within the control device 301. In FIG. 6, the components contained in the processor 602 are typically implemented by the computer programs executed by the processor 602, although they may also be implemented in dedicated hardware.

A transceiver 604 controls the transmission and the reception of data between the control device 301 and an external node, such as the reproducing device 302, the content server 303, the Rights Issuer 304, and so on. Although the transceiver 604 is described as a single block for simplicity in FIG. 6, it should be noted that the transceiver 604 may comprise a plurality of components such as a Bluetooth® transceiver and Ethernet® transceiver.

A control unit 606 controls the reproducing device 302 to reproduce the Media Object. In some embodiments, the control unit 606 obtains a list of Media Objects, which are contained in the content server 303, from the content server 303. The control unit 606 then shows the list on a display 608 so that the owner of the control device can select a Media Object, which the owner wants to be reproduced, via an operation unit 610 (e.g., a keyboard). The control unit 606 selects the Media Object to be reproduced in response to the operation by the operation unit 610, and sends an indication of the selected Media Object to the reproducing device 302. The indication includes a Universal Resource Identifier (URI), from which the reproducing device 302 receives the selected Media Object. Alternatively, in the case that the reproducing device 302 possesses Media Objects, the control unit 606 may obtain the list from the reproducing device 302 and the indication may include the file path of the selected Media Object.

A receiving unit 612 receives a request to acquire a RO that enables reproduction of the selected Media Object. The request comprises location information (typically, URI) of the RO and authentication information (typically, a signature based on the Public Key Infrastructure (PKI)) of the reproducing device 302.

An acquiring unit 614 “endorses” the request received by the receiving unit 612. That is, the acquiring unit 614 generates a new request (“endorsed request”) based on the received request. The acquiring unit 614 then acquires the RO by sending the endorsed request to the URI in the received request. In some embodiments, the endorsed request may comprise authentication information (typically, a signature based on PKI) of the control device 301. The authentication information is generated based on the information such as a private key of the control device 301, which may be stored in a memory 616. The memory 616 may be a Universal Integrated Circuit Card (UICC) in the case that the control device 301 is a cellular phone. The endorsed request may also comprise identification (e.g., Device ID) that is associated with the owner of the control device 301, so that the owner is eventually charged for the acquisition of the RO.

A sending unit 616 sends the RO acquired by the acquiring unit 614 to the reproducing device 302 so that it can decrypt and reproduce the selected Media Object.

Reproducing Device:

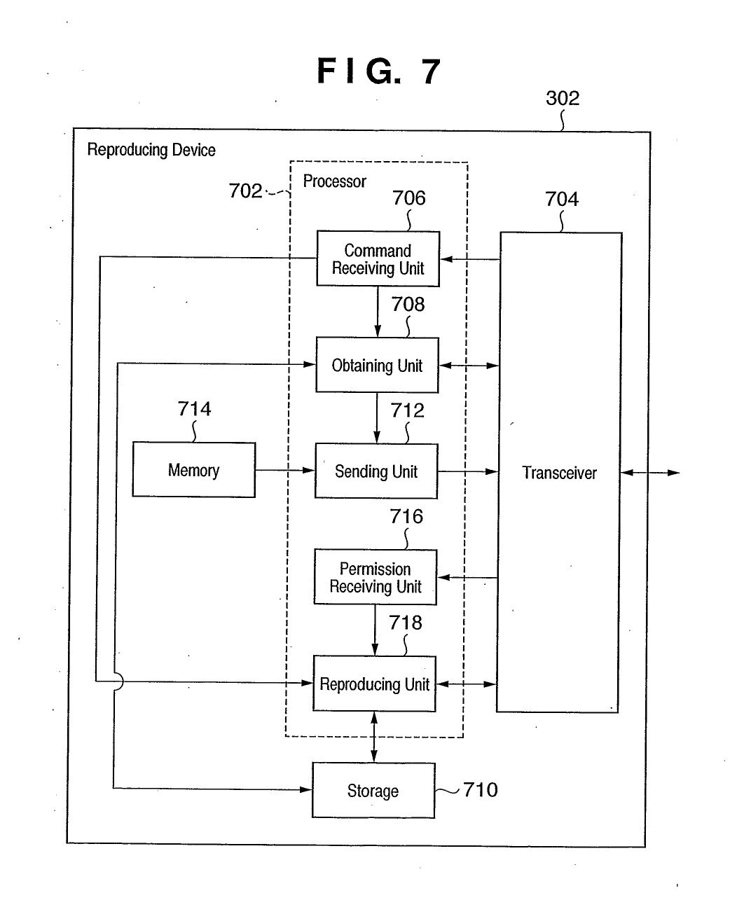

FIG. 7 illustrates a block diagram of the reproducing device 302 of the reproducing system 300. A processor 702 executes computer programs such as firmware and an operating system, thereby controlling each of the components contained within the reproducing device 302. In FIG. 7, the components contained in the processor 702 are typically implemented by the computer programs executed by the processor 702, although they may also be implemented in dedicated hardware.

A transceiver 704 controls the transmission and reception of data between the reproducing device 302 and an external node, such as the control device 301, the content server 303, the Rights Issuer 304, and so on. Although the transceiver 704 is described as a single block for simplicity in FIG. 7, it should be noted that the transceiver 704 may comprise a plurality of components such as a Bluetooth® transceiver and Ethernet® transceiver.

A command receiving unit 706 receives the command to reproduce the Media Object from the control device 301. The command includes location information (typically, URI) that indicates the location of the Media Object to be reproduced. In some embodiments, the command receiving unit 706 also receives location information regarding the control device 301, which is used by a sending unit 712 to send a request to acquire an RO.

An obtaining unit 708 accesses the URI, which is included in the command, and tries to retrieve the Media Object. As the Media Object is protected using DRM, the content server 303 that contains the Media Object returns URI of the Rights Issuer 304. By accessing the returned URI, the obtaining unit 708 obtains URI of an RO that enables reproduction of the Media Object. Alternatively, in the case that the Media Object is contained in a storage 710, the obtaining unit 708 receives the file path included in the command and obtains the URI of the Rights Issuer 304 from metadata of the Media Object.

A sending unit 712 sends a request to acquire the RO to the control device 301. In other words, the sending unit 712 “delegates” acquisition of the RO to the control device 301. The request comprises the URI of the RO, from which the control device 301 acquires the RO. The request also comprises authentication information (typically, a signature based on PKI) of the reproducing device 302 so that the Rights Issuer in turn can determine the credibility of the reproducing device 302. The sending unit 712 generates the authentication information based on the information such as a private key of the reproducing device 302, which may be stored in a memory 714. The memory 714 may be a Static Random Access Memory (SRAM).

A permission receiving unit 716 receives the RO from the control device 301 as a response to the request.

A reproducing unit 718 then decrypts and reproduces the Media Object using the RO received by the permission receiving unit 716. Based on the location information included in the command, the reproducing unit 718 retrieves the Media Object from the content server 303 or the storage 710.

Rights Issuer:

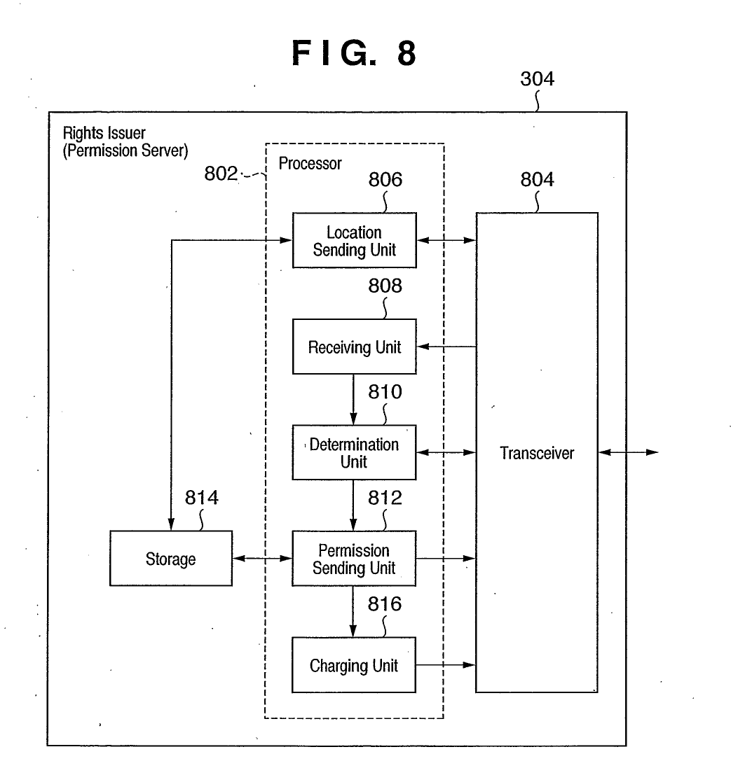

FIG. 8 illustrates a block diagram of the Rights Issuer 304 of the reproducing system 300. A processor 802 executes computer programs such as firmware and an operating system, thereby controlling each of the components contained within the Rights Issuer 304. In FIG. 8, the components contained in the processor 802 are typically implemented by the computer programs executed by the processor 802, although they may also be implemented in dedicated hardware.

A transceiver 804 controls the transmission and reception of data between the Rights Issuer 304 and an external node, such as the control device 301, the reproducing device 302, and so on. Although the transceiver 804 is described as a single block for simplicity in FIG. 8, it should be noted that the transceiver 804 may comprise a plurality of components such as a Bluetooth® transceiver and Ethernet® transceiver.

A location sending unit 806 sends location information (typically, URI) of an RO to the reproducing device 302, when the location sending unit 806 is notified by the reproducing device 302 which Media Object is to be reproduced. The location sending unit 806 obtains the location information from a storage 814, which contains ROs.

A receiving unit 808 receives a request from the control device 301 to acquire the RO by using the location information sent by the location sending unit 806. The request includes authentication information (typically, a signature based on PKI) of the reproducing device 302.

A determination unit 810 determines whether or not the reproducing device is authenticated by, for example, referring to CRL managed by the OCSP server 305 via OCSP. That is, the determination unit 810 determines whether or not the authentication information is revoked.

A permission sending unit 812 retrieves the RO from the storage 814 and sends it to the control device 301, if the determination unit 810 determines that the reproducing device is authenticated.

In some embodiments, the request received by the receiving, unit 808 also includes authentication information of the control device 301, and the determination unit determines whether or not the control device 301 is authenticated. The permission sending unit sends the RO to the control device 301 in the case that both the reproducing device 302 and the control device 301 are authenticated.

In some embodiments, the receiving unit 808 also receives identification (e.g., Device ID) that is associated with the owner of the control device 301. A charging unit 816 charges the owner for the acquisition of the RO. More specifically, the charging unit 816 sends the identification to the charging server 306 with pricing information so that the charging server 306 can charge the owner.

Exemplary Procedure of Reproduction:

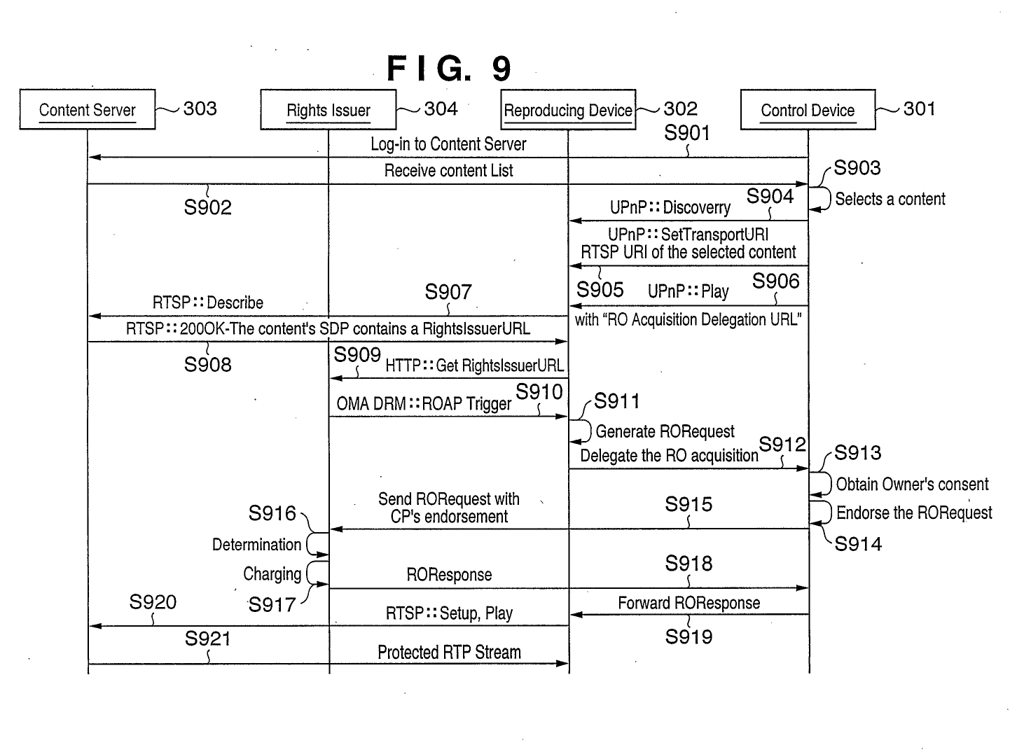

FIG. 9 is a flowchart showing process performed in the reproducing system 300.

In step S901, the control device 301 logs on to the content server 303 according to e.g. the owner's operation using a built-in browser on the control device 301. The HTTP URL for the log-in is pre-known to the owner.

In step S902, the control device 301 receives a list of content (Media Objects) stored in the content server 303. Each item in the list contains a corresponding RTSP URI from which the content can be streamed.

In step S903, the owner browses the list and selects the Media Object to be reproduced. The control device 301 selects the Media Object in response to the owner's selection.

In step S904, the control device 301 discovers the reproducing device 302 (MediaRenderer) using UPnP discovery process [5].

In step S905, the control device 301 sets the target RTSP. URI obtained in steps S902 and S903 above to the reproducing device 302 using an UPnP AVSetTransportURI action defined in [6].

In step S906, the control device 301 sends a UPnP Play action command [6] in order to start playback (reproduction). In this embodiment, the UPnP Play action is extended to enable the action request to carry an “RO Acquisition Delegation URI” as an additional argument. The Delegation URI is an HTTP URL used by the reproducing device 302 to send a delegation request to the control device 301 at the subsequent step S912. This means that the control device 301 has to wait for a delegation request from the reproducing device 302 at this specified URI.

In step S907, upon being commanded the Play action, the reproducing device 302 sends an RTSP::Describe request to the RTSP URI, which was pre-set in step S905. This request is to be received by the content server 303.

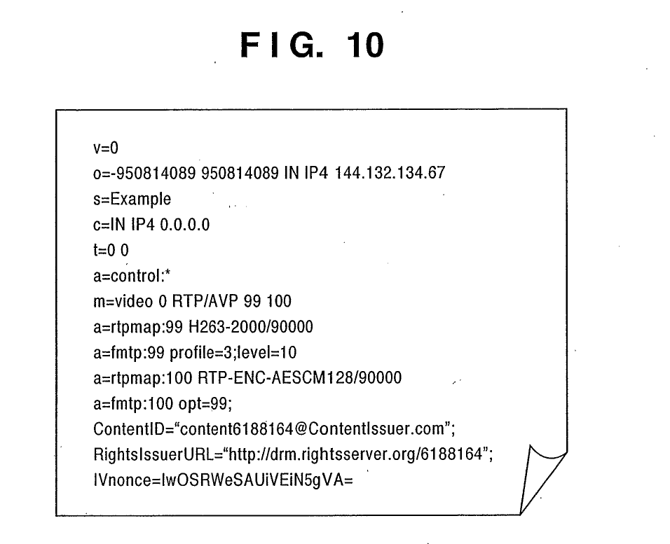

In step S908, the content server 303 returns SDP [11] of the content in 200 OK response. Since this embodiment assumes both that the content is protected in the form of PDCF (Packetized DRM Content Format: a stream-able OMA DRM content format [7]) and that SDP signaling defined in Packet-switched Streaming Service in 3GPP [8] (specifies how to stream PDCF contents using RTSP) is used, the returned SDP contains a RightsIssuerURL. FIG. 10 illustrates an example of SDP returned by the content server 303.

In step S909, when receiving the SDP, the reproducing device 302 comes to know the content is protected. Therefore, it sends an HTTP Get request to the RightsIssuerURL contained in the SDP to retrieve a ROAP Trigger from Rights Issuer.

In step S910, Rights Issuer 304 returns the ROAP Trigger. The ROAP Trigger type is ROAcquisitionTrigger. The ROAP Trigger includes URI of an RO that enables reproduction of Media Object selected at step S903.

In step S911, the reproducing device 302 generates a ROAP-RORequest message, which is signed by the reproducing device 302.

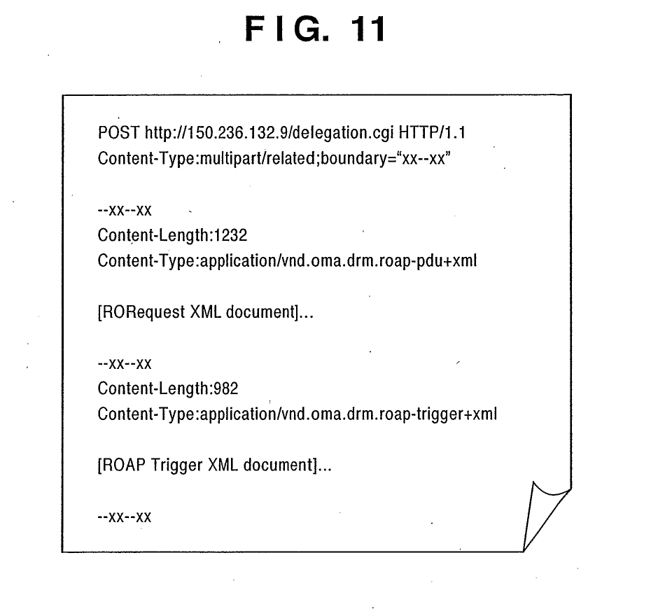

In step S912, the reproducing device 302 sends a request message containing both the RORequest and the ROAP Trigger received from the Rights Issuer to the RO Acquisition Delegation URI. An example of this request message is shown in FIG. 11. This example shows that the request is HTTP-POSTed to the delegation URI and the RORequest and ROAP Trigger are multiplexed into the HTTP request.

In step S913, the control device 301 attempts to obtain owner's consent through, for example, some form of a user interface shown on the display 608.

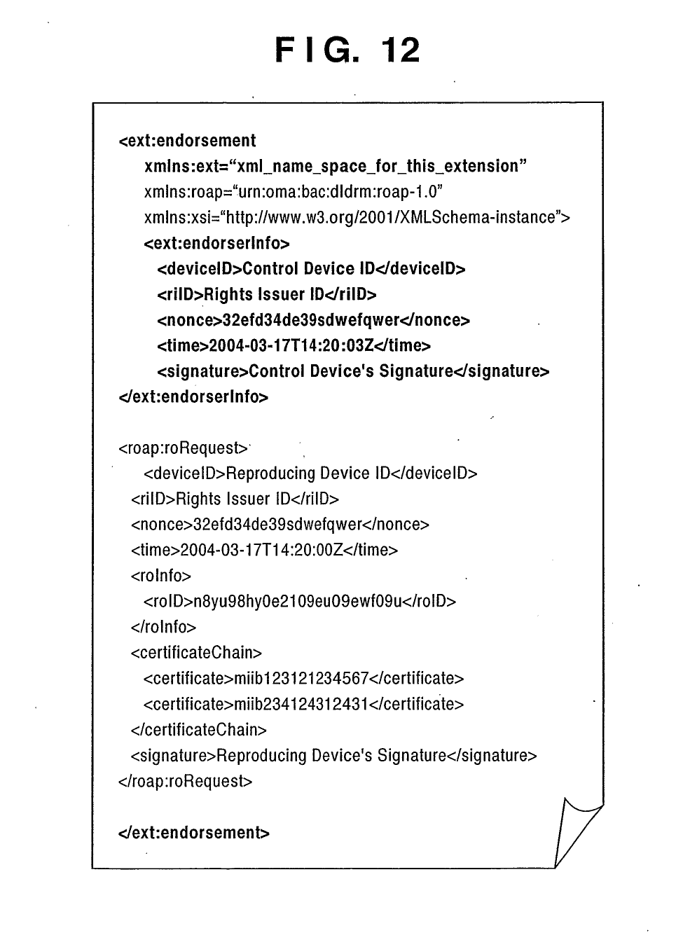

In step S914, the control device 301 endorses the RORequest to generate the endorsed request. As shown in FIG. 12, in this example, the endorsed RORequest is encapsulated in another XML element, <endorsement>, so as to indicate to the Rights Issuer 304 that this RORequest is endorsed. In this example, a new XML namespace is defined for the <endorsement> element. <endorserInfo> element carries the endorsing Device information such as Device ID. The <signature> element stores a signature of the control device 301 that covers an entire XML document rooted by the <endorsement>. The syntax of each element within the <endorserInfo> follows OMA DRM 2.0 [1].

In step S915, the control device 301 sends the endorsed RORequest (the message shown in FIG. 11) to the Rights Issuer 304, which can be located by a ROAP URL in the ROAP Trigger received from the reproducing device 302 in step S912.

In step S916, if the Rights Issuer 304 finds an <endorsement> element in RORequest, it interprets this request as being endorsed. In this case, the Rights Issuer 304 decapsulates the endorser information (information of the control device 301) and the RORequest generated by the reproducing device 302. Using the signature of the reproducing device 302, the Rights Issuer 304 determines whether or not the reproducing device 302 is authenticated. This determination can be conducted by, for example, checking CRL managed by the OCSP server 305.

In step S917, the Rights Issuer 304 sends the Device ID of the control device with pricing information of the RO to be issued to the charging server 306, so that the charging server 306 can charge the owner of the control device 301 for the RO.

In step S918, (in the case that the reproducing device 302 is determined to be authenticated,) the Rights Issuer 304 generates a ROResponse that contains an RO entitled to the reproducing device 302 (i.e., the RO is protected with a public-key of the reproducing device 302). The ROResponse is eventually sent back to the control device 301.

In step S919, the control device 301 forwards the ROResponse to the reproducing device 302 as a response to the delegation request at the step S912.

In step S920, since the reproducing device 302 acquires the RO, it is ready to receive protected content (by means of streaming in this example) from the content server 303. The reproducing device 302 sends RTSP::Setup and RTSP::Play commands to start receiving the stream.

In step S921, the reproducing device 302 decrypts and reproduces the protected streaming from the content server 303 using the RO.

As described above, an authentication between end Devices shall take place for the existing solution (sub-licensing technology) while the present invention does not require it. That is, in the existing solution, the sub-licensing Device shall authenticate the sub-licensed Device in order to make sure the sub-licensed Device is a certified device (i.e., trusted device). Also, the function is required for the sub-licensing Device to check revocation status of the sub-licensed Device's certificate referring to CRL in order to make sure the sub-licensed Device is not compromised.

On the other hand, the present invention does not require the control device to authenticate the reproducing device because the reproducing device is authenticated by the Rights Issuer which verifies a digital signature of the reproducing device in the (endorsed) RORequest, and thus does not require the above mentioned function for the control device to check the certificate revocation.

Accordingly, processing load for the control device, which is usually a mobile device with small bandwidth and less processing power, is reduced.

In addition, the Rights Issuer can obtain all information contained in the RORequest generated by the reproducing device because the control device only capsules the RORequest in the endorsed request.

Abbreviations:

### UPnP Universal Plug and Play

### AV Audio Visual

### SIM Subscriber Identity Module

### IMSI International Mobile Subscriber Identity

### OMA Open Mobile Alliance

### DRM Digital Rights Management

### CP UPnP Control Point

### SDP Session Description Protocol

### DCF DRM Content Format

### PDCF Packetized DCF

### OCSP Online Certificate Status Protocol

### PKI Public Key Infrastructure

### REFERENCES

[1] OMA DRM Specification, Approved Version 2.0-3 Mar. 2006
[2] X.509 Internet Public Key Infrastructure Online Certificate Status Protocol—OCSP, RFC2560
[3] SCE Requirements, Draft Version 2.0-22 May 2006, OMA-RD-SCE-V1_{—}0-20060522-D
[4] “Content and License Delivery to Shared Devices,” Patent Application Publication, Pub. No.: US 2006/0036554 A1
[5] UPnP Device Architecture 1.0, http://www.upnp.org/resources/documents/CleanUPnPDA101-20031202s.pdf
[6] UpnP AVTransport:l Service Template Version 1.01, http://www.upnp.org/standardizeddcps/documents/AVTransport1.0.pdf
[7] OMA DRM Content Format, Approved Version 2.0-3 Mar. 2006
[8] 3GPP TS 26.234 Transport end-to-end Packet-switched Streaming Service (PSS); Protocol and codecs (Release 6)
[9] UPnP MediaServer 1.0, http://www.upnp.org/standardizeddcps/documents/MediaServer1.0.pdf
[10] UPnP MediaRenderer 1.0, http://www.upnp.org/standardizeddcps/documents/MediaRenderer1.0_{—}000.pdf
[11] Session Description Protocol (SDP), RFC2327

1. A control device, which is associated with charging information of an owner of the control device, comprising:
control means for controlling a reproducing device to reproduce multimedia data, the reproducing device not being associated with the charging information of the owner of the control device;
receiving means for receiving, from the reproducing device, a request to acquiring permission data contained in a permission server and location information that indicates a location of the permission data, said permission data enabling reproduction of the multimedia data, and said request comprising authentication information of the reproducing device;
acquiring means for acquiring the permission data from the location indicated by the location information by generating an endorsed request based on the received request and by sending the endorsed request to the location indicated by the location information, said endorsed request comprising identification of the control device that is associated with the charging information of the owner of the control device; and
sending means for sending the permission data to the reproducing device.

2. (canceled)

3. The control device according to claim 1, wherein the control means sends location information that indicates a location to which the reproducing device sends the request.

4. The control device according to 1, wherein the acquiring means sends authentication information of the control device to the permission server.

5. The control device according to claim 4, wherein the authentication information of the reproducing device and the authentication information of the control device are signatures based on Public Key Infrastructure.

6. The control device according to claim 1, wherein the control device and the reproducing device are connected to each other using Universal Plug and Play.

7. A reproducing device comprising:
command receiving means for receiving, from a control device, a command to reproduce multimedia data, the control device being associated with charging information of an owner of the control device and the reproducing device not being associated with the charging information of the owner of the control device;
obtaining means for obtaining, based on the multimedia data, location information that indicates a location of permission data contained in a permission server, said permission data enabling reproduction of the multimedia data;
sending means for sending, to the control device, the location information and request for acquiring the permission data, said request comprising authentication information of the reproducing device;
permission receiving means for receiving, from the control device, the permission data that is received by the control device as a response to an endorsed request generated by the control device based on the request and sent to the location indicated by the location information, said endorsed request comprising identification of the control device that is associated with the charging information of the owner of the control device;
and
reproducing means for reproducing the multimedia data using the permission data.

8. The reproducing device according to claim 7, wherein the command receiving means receives location information that indicates a location to which the sending means sends the request.

9. The reproducing device according to claim 7, wherein the multimedia data is contained in a storage of the reproducing device.

10. The reproducing device according to claim 6, wherein the authentication information is a signature based on Public Key Infrastructure.

11. The reproducing device according to claim 7, wherein the reproducing device and the control device are connected to each other using Universal Plug and Play.

12. A permission server comprising:
location sending means for sending, to a reproducing device, location information that indicates a location of permission data contained in the permission server, said permission data enabling reproduction of multimedia data,
the reproducing device sending a request for acquiring permission data contained in the permission server, the request being received by a control device, the request comprising authentication information of the reproducing device, the control device being associated with charging information of an owner of the control device and the reproducing device not being associated with the charging information of the owner of the control device;
receiving means for receiving, from a control device, at the location indicated by the location information, an endorsed request generated by the control device based on the request, said endorsed request comprising identification of the control device that is associated with the charging information of the owner of the control device,
determination means for determining whether or not the reproducing device is authenticated based on the authentication information;
and
permission sending means for sending the permission data to the control device in response to the endorsed request in the case that the determination means determines that the reproducing device is authenticated.

13. The permission server according to claim 12, wherein the determination means checks whether or not the authentication information is revoked via Online Certificate Status Protocol, and determines that the reproducing device is not authenticated in the case that the authentication information is revoked.

14. The permission server according to claim 12, further comprising charging means for charging the owner for the permission data sent by the permission sending means based on the identification.

15. The permission server according to claim 12, wherein the request comprises authentication information of the control device.

16. The permission server according to claim 15, wherein
the determination means determines whether or not the control device is authenticated, and
the permission sending means sends the permission data in the case that the determination means determines that both the reproducing device and the control device are authenticated.

17. The permission server according to claim 15, wherein the authentication information of the reproducing device and the authentication information of the control device are signatures based on Public Key Infrastructure.

18.-34. (canceled)
